(19) United States
(12) Patent Application Publication
(10) Pub. No.: US 2023/0125997 A1
(43) Pub. Date: Apr. 27, 2023

(54) ROTOMOLD COOLER

(71) Applicant: CORKCICLE, LLC, Orlando, FL (US)

(72) Inventors: Christian Poulsen, Brooklyn, NY (US); Michael Gawtry, Freeport, ME (US); Meredith Hollandsworth, Baltimore, MD (US)

(73) Assignee: CORKCICLE, LLC, Orlando, FL (US)

(21) Appl. No.: 17/970,046

(22) Filed: Oct. 20, 2022

Related U.S. Application Data
(60) Provisional application No. 63/270,640, filed on Oct. 22, 2021.

(51) Int. Cl. B65D 25/08; B65D 43/16; B65D 81/26; A47J 47/00

(52) U.S. Cl. CPC B65D 25/08; A47J 47/005; B65D 43/163; B65D 81/261; B65D 2543/00101

(57) ABSTRACT

An insulated container can include a body having a length, width and height. The body can include an interior volume, an internal rim and an internal slot extending into the interior volume. The insulated container can further include a lid. The lid can have an open position and a closed position. The insulated container can have a cutting board. The cutting board can be complementary in shape to the internal rim and seat on the internal rim. The cutting board also can seat in the internal slot.

This application claims priority to and the benefit of U.S. Prov. Pat. App. No. 63/270,640, filed on Oct. 22, 2021, and is incorporated herein by reference in its entirety.

### BACKGROUND OF THE DISCLOSURE

### Field of the Disclosure

This disclosure relates in general to insulated containers and, in particular, to rotationally molded insulated cooler for food and beverages.

### Background

Conventional ice chests and insulated coolers are well known for maintaining a desirable temperature for the food and beverages they contain. Although there is a large variety of such products, improvements in utility, function and design of insulated coolers continue to be of interest.

### Summary

Embodiments of a system, method and apparatus for an insulated container are disclosed. For example, the insulated container can include a body having a length, width and height. The body can include an interior volume, an internal rim and an internal slot extending into the interior volume. The insulated container can further include a lid. The lid can have an open position and a closed position. The insulated container can have a cutting board. The cutting board can be complementary in shape to the internal rim and can seat on the internal rim. The cutting board also can seat in the internal slot. The body and lid can have outer perimeter corners with a radius of curvature in a range of about 5% to about 15% of the width.

### BRIEF DESCRIPTION OF THE DRAWINGS

So that the manner in which the features and advantages of the embodiments are attained and can be understood in more detail, a more particular description can be had by reference to the embodiments thereof that are illustrated in the appended drawings. However, the drawings illustrate only some embodiments and therefore are not to be considered limiting in scope as there can be other equally effective embodiments.

FIGS. 1-3 are various isometric views of an embodiment of a cooler.

FIGS. 4-7 are top, front, side and rear views, respectively, of the cooler of FIGS. 1-3.

FIGS. 8A and 8B are isometric views of the cooler of FIGS. 1-3 with the lid open and is shown in two different configurations.

FIGS. 9A and 9B includes isometric views of a cutting board for the respective configurations of FIGS. 8A and 8B.

FIG. 10 is an exploded front isometric view of a portion of the cooler of FIG. 1.

FIGS. 11 and 12 are isometric views of another embodiment of a cooler.

FIGS. 13-19 are various isometric views (FIG. 14 is partially exploded) of embodiments of the cooler of FIGS. 11 and 12 with the lid open and in various internal configurations.

FIGS. 20-22 are isometric views of a third embodiment of a cooler.

### DETAILED DESCRIPTION

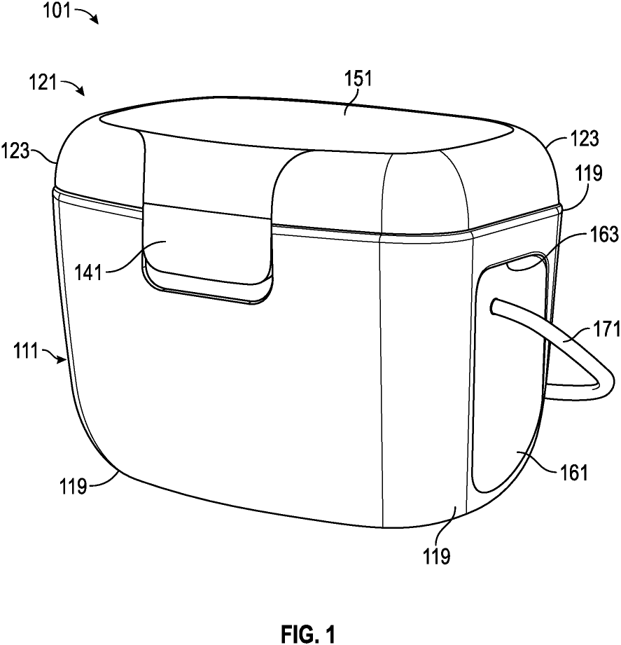

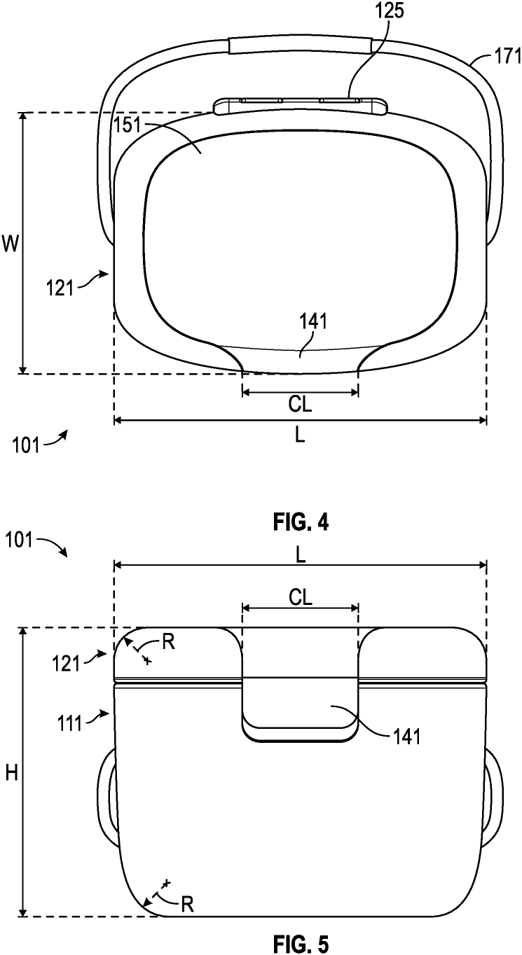

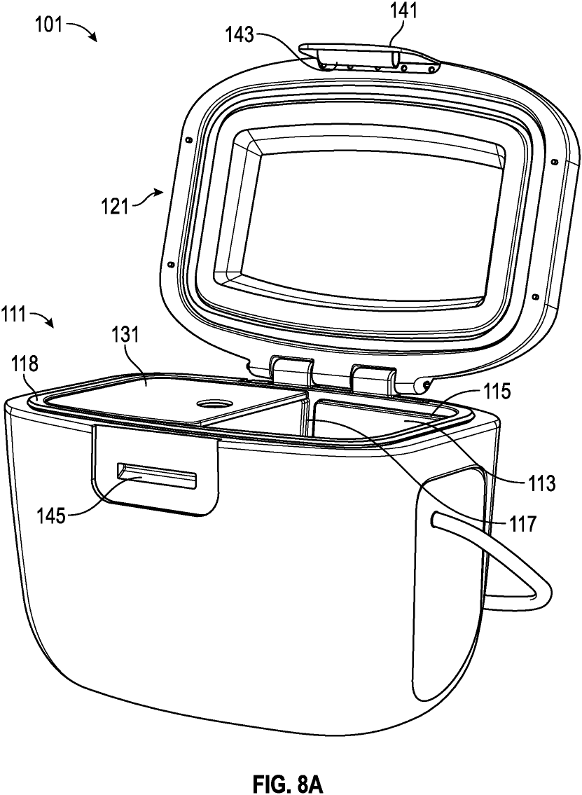

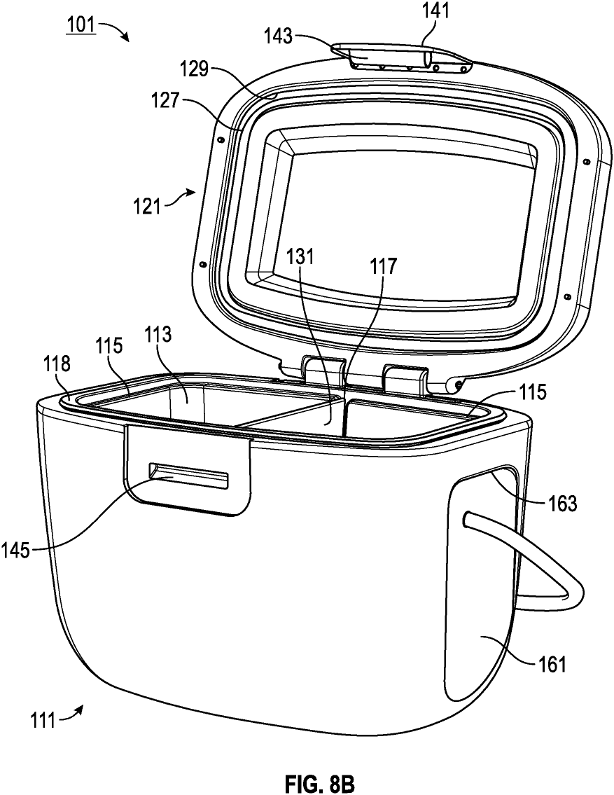

This disclosure and FIGS. 1-7 8A 9A 9B 10 include embodiments of an insulated container 101. For example, the insulated container 101 can include a body 111 having a length L, width W and height H (FIGS. 4-6). The body 111 can include an interior volume 113 (FIGS. 8A-8B), an internal rim 115 and one or more internal slots 117 (e.g., one shown) extending into the interior volume 113. The insulated container 101 may comprise one or more sizes, such as interior volumes comprising 13 quarts, 26 quarts, 48 quarts, for example.

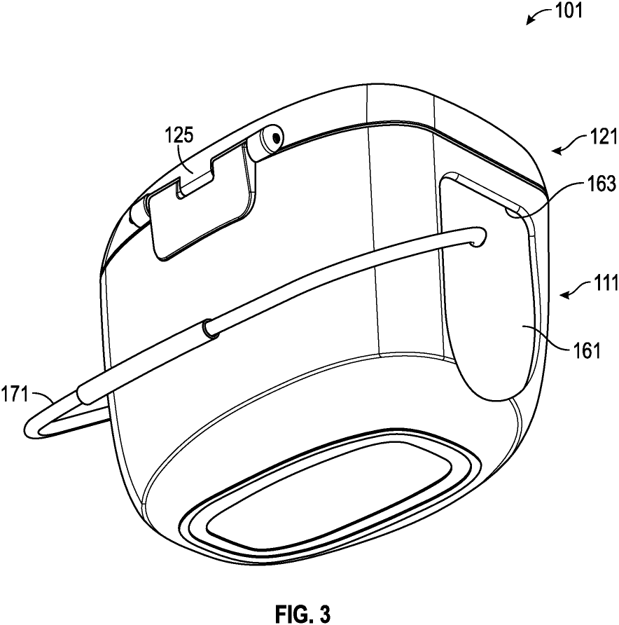

The insulated container 101 can further include a lid 121. The lid 121 can be pivotally coupled to the body 111, such as with a hinge 125 (FIG. 3). The lid 121 can have an open position (FIGS. 8A and 8B) to expose the interior volume 113 of the body 111, and a closed position (FIGS. 1-3) to cover and seal the interior volume 113 of the body 101. The body 111 and lid 121 can be formed from various materials. In some versions, each of the body 111 and lid 121 can be rotationally molded and comprise a polymer, such as polyethylene.

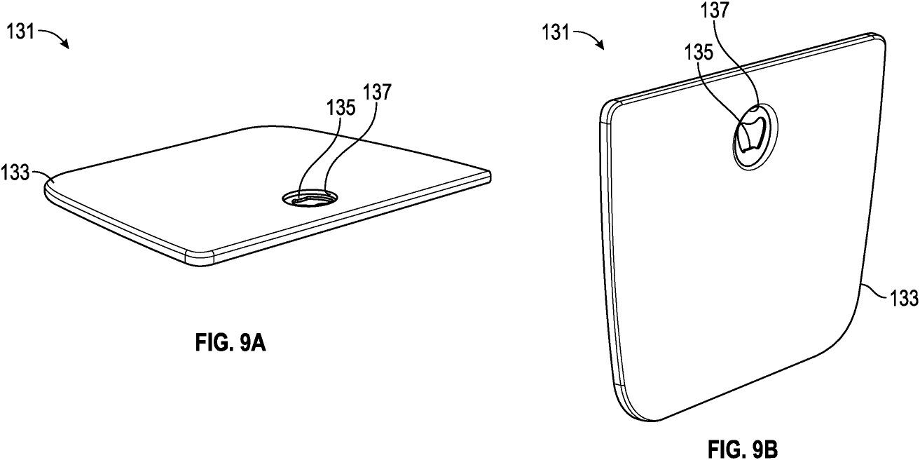

Embodiments of the insulated container 101 can further include one or more cutting boards 131. See, e.g., FIGS. 8A, 8B, 9A and 9B. Versions of the cutting board 131 can have an outer perimeter 133 that is complementary in shape to the internal rim 115 of the body 111. For example, the cutting board 131 can be generally shaped like a capital “D.” The cutting board 131 can be configured to seat on the internal rim 115 of the body 111 in a cover position (FIG. 8A). In addition and alternatively, the cutting board 131 can be configured to seat in the internal slot 117 in a partition position (FIG. 8B) to divide the interior volume 113 of the body 111 into sub-volumes.

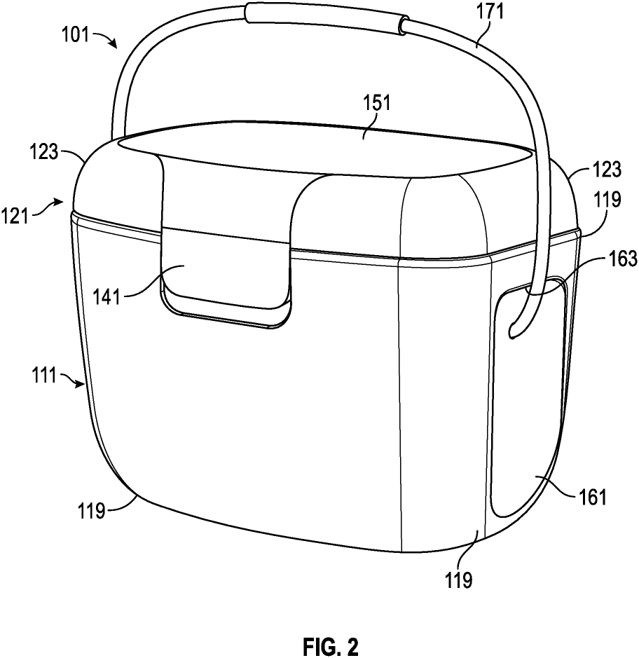

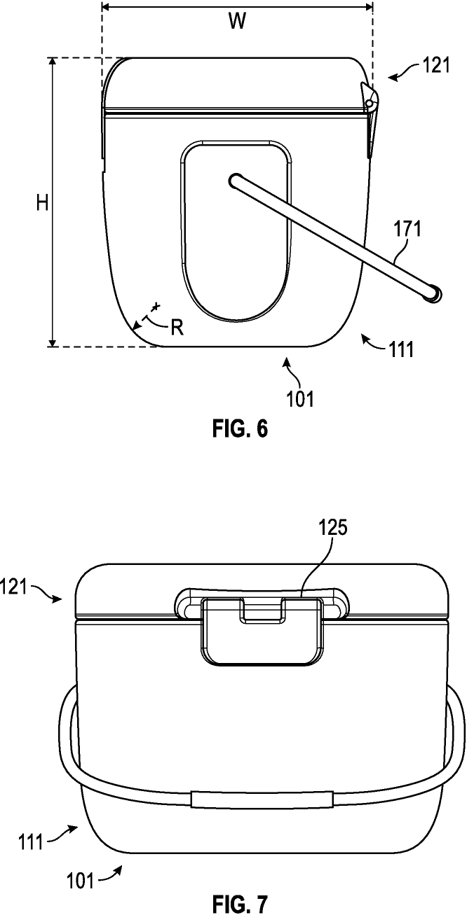

In some examples, each of the body 111 and the lid 121 can comprise outer perimeter corners 119, 123 (FIGS. 1-2), respectively, that consist of large, enhanced rounded features. The rounded features can have a radius of curvature R (FIGS. 5-6), such as a minimum radius of curvature. Embodiments of the radius of curvature R can be in a range of about 5% to about 15% of the width W (FIG. 4) of the respective body 111 and lid 121. In other embodiments, the radius of curvature R can be in a range of about 8% to about 12% of the width W of the respective body 111 and lid 121.

Versions of the lid 121 can comprise a closure 141, such as a single, clasp-type closure. The closure 141 can include a rib 143 (FIGS. 8A-8B) that is configured, when the lid 121 is in the closed position, to seat in a slot 145 in a front of the body 111, such as at a center of the length L of the body 111.

In some embodiments, the closure 141 can comprise a closure length CL (FIGS. 4-5). The closure length CL can be in a range of about 20% to about 40% of the length L of the body 111.

Examples of the insulated container 101 can have, in the closed position, outer surfaces of the closure 141 that are substantially flush with outer surfaces of the body 111 and/or the lid 121. The closure 141 can be flexibly cantilevered from the lid 121. The closure 141 can have a limited range of flexible motion, relative to the lid 121, to secure and release the lid 121 relative to the body 111. In one example, the closure 141 is flexibly mounted–not pivotally mounted--to the lid 121.

Embodiments of the insulated container 101 can further comprise a pad 151 mounted to the lid 121. In some versions, the pad 151 is mounted in a recess on top of the lid 121. A top surface of the pad 151 can be substantially flush with a top surface of the lid 121. In an example, the closure 141 and the pad 151 can be formed together as a single, monolithic, integral silicone structure.

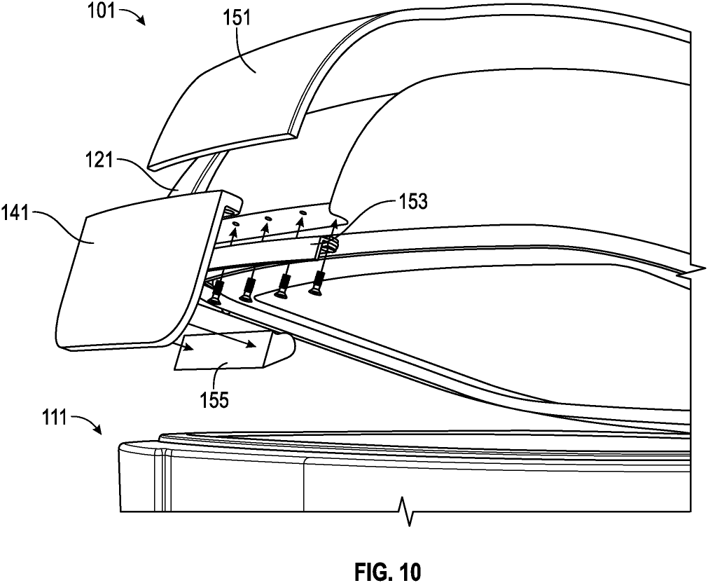

Embodiments of the closure 141 can include one or more rigid reinforcements 153, 155 (e.g., two shown in FIG. 10). Each rigid reinforcement 153, 155 can comprise an injection-molded polymer. The rigid reinforcements 153, 155 can be molded inside the closure 141. The rigid reinforcement 153 can fastened to an underside of the lid 121 at an upper end of the closure 141. The other rigid reinforcement 155 can be molded inside a lower end of the closure 141.

Referring again to FIGS. 9A and 9B, the cutting board 131 can comprise a bottle opener 135. The bottle opener 135 can be formed integrally within the cutting board 131. Examples of the cutting board 131 can be molded around the bottle opener 135. The cutting board 131 can include apertures 137 to provide access to the bottle opener 135 from both major surfaces of the cutting board 131.

As shown in FIGS. 8A and 8B, the internal rim 115 can be horizontal. The internal rim can circumscribe an entire upper end of the body 111. The cutting board 131 can be horizontal when in the cover position. In contrast, the internal slot 117 can be vertical. The cutting board 131 can be vertical when in the partition position.

In some embodiments, a surface area of the cutting board 131 can be about half (e.g., about 40% to about 50%) of an upper surface area of the interior volume 113 of the body 111. In the cover position, the cutting board 131 can cover about half of the interior volume 113 of the body 111. In some versions, in the cover position, the cutting board 131 is reversible on the internal rim 115 to cover either side of the interior volume 113 of the body 111, such that there are two cover positions. For example, in a first one of the cover positions, the cutting board 131 can have a first orientation and, in a second one of the cover positions, the cutting board 131 can have a second orientation that comprises a mirror-image of the first orientation.

In addition, the lid 121 can include a gasket 127 (FIG. 8B) seated in a groove 129 in an interior lower surface of the lid 121. The body 111 can include a raised lip 118 that can circumscribe an upper surface of the body and seat against the gasket 127 when the lid 121 is in the closed position.

Embodiments of the insulated container 101 can further include the body 111 having concave lateral sides 161 (FIGS. 1-3). Each of the concave lateral sides 161 can include a handle 163. Each handle 163 can be an integrated, recessed body handle adjacent an upper end of the body 111. The insulated container 101 can further comprise a tubular handle 171. The tubular handle 171 can be curved and have ends. Each end of the tubular handle 171 can intersect and be mounted to the body 111 at the respective concave lateral sides 161 of the body 111 beneath the respective body handles 163.

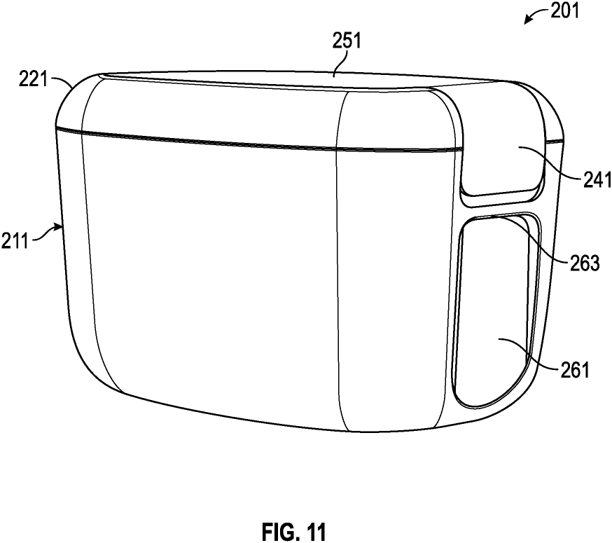

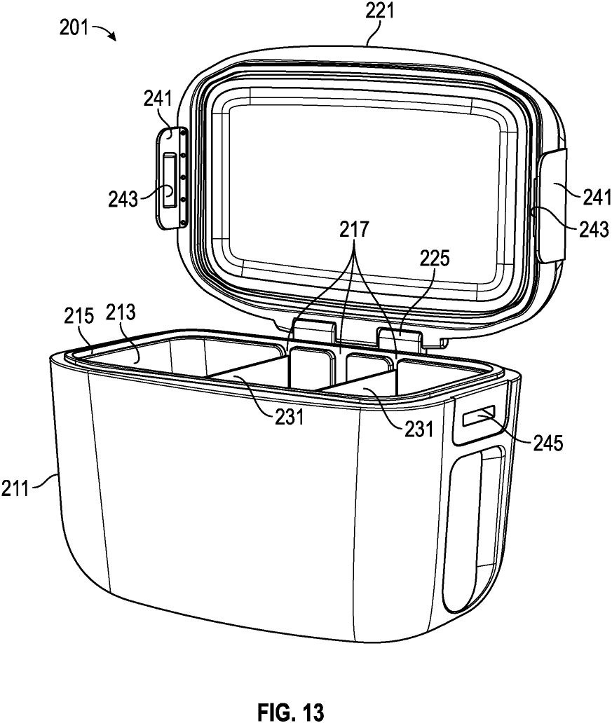

FIGS. 11-19 depict another embodiment of an insulated container 201 that is at least somewhat similar to the insulated container 101. Versions of insulated container 201 can have similar or even identical features and components as insulated container 101. For example, the insulated container 201 can include a body 211 with an interior volume 213 (FIG. 13), an internal rim 215 and one or more internal slots 217 extending into the interior volume 213.

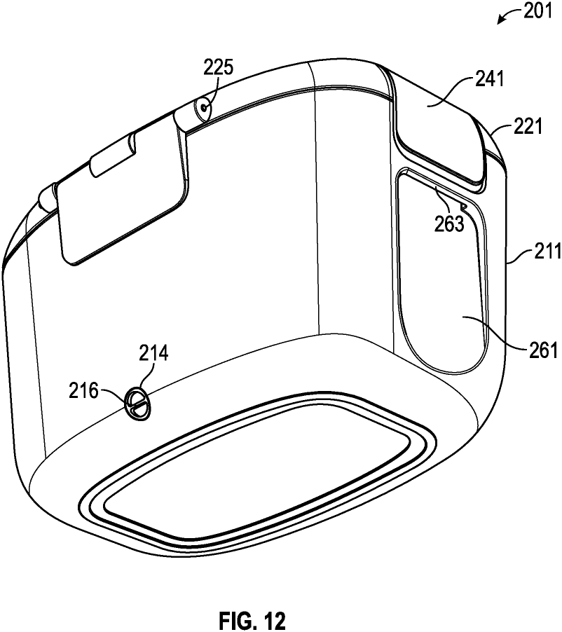

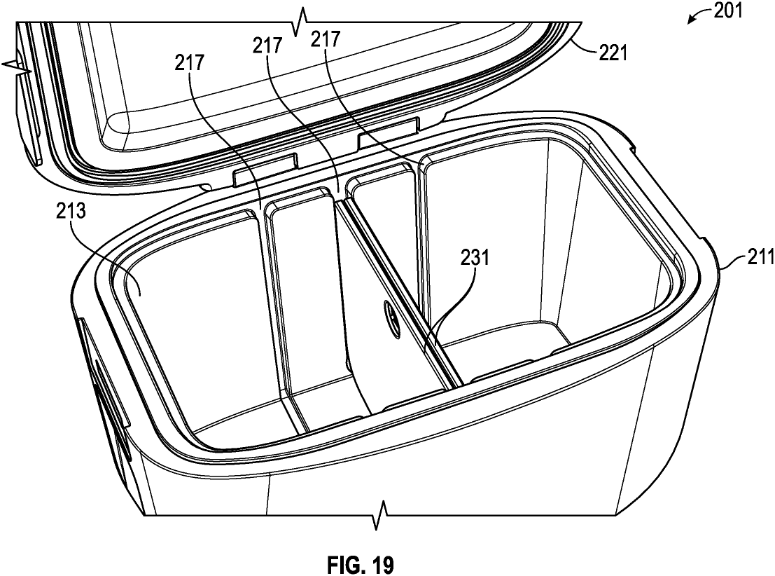

FIGS. 12 and 18 depict embodiments of the body 211 having a drain port 214 that can be threaded. A plug 216, which also can be threaded, can be releasably mounted in the drain port 214. When the plug 216 is fully seated in the drain port 214 (FIG. 12), an exterior of the plug 216 can be flush with an exterior of the body 211, in some examples. In addition, the plug 216 may be tethered to the body 211 so that it is not easily misplaced when not installed in the drain port 214.

The insulated container 201 can further include a lid 221. The lid 221 can be pivotally coupled to the body 211, such as with a hinge 225 (FIG. 12). The lid 221 can have an open position (FIG. 13) to expose the interior volume 213 of the body 211, and a closed position (FIG. 11) to cover and seal the interior volume 213 of the body 201. The body 211 and lid 221 can be formed from various materials, such as polyethylene or other polymers, which can be rotationally molded.

Embodiments of the insulated container 201 can further include one or more cutting boards 231 (e.g., two shown in FIG. 13). Versions of the cutting board 231 can be similar or even identical to cutting board 131, described above. Examples of the cutting boards 231 can comprise one or more bottle openers 235 (e.g., one shown per cutting board 231, in FIG. 15). The bottle opener 235 can be similar or identical to bottle opener 135, described above.

In FIGS. 13 and 18, the cutting boards 231 are shown slidably mounted in vertical orientations in the two outer slots 213. This is one optional partition position to divide the interior volume 213 of the body 211 into sub-volumes. In FIGS. 13 and 18, the positions of the cutting boards 231 are spaced apart to divide the interior volume 213 into three compartments.

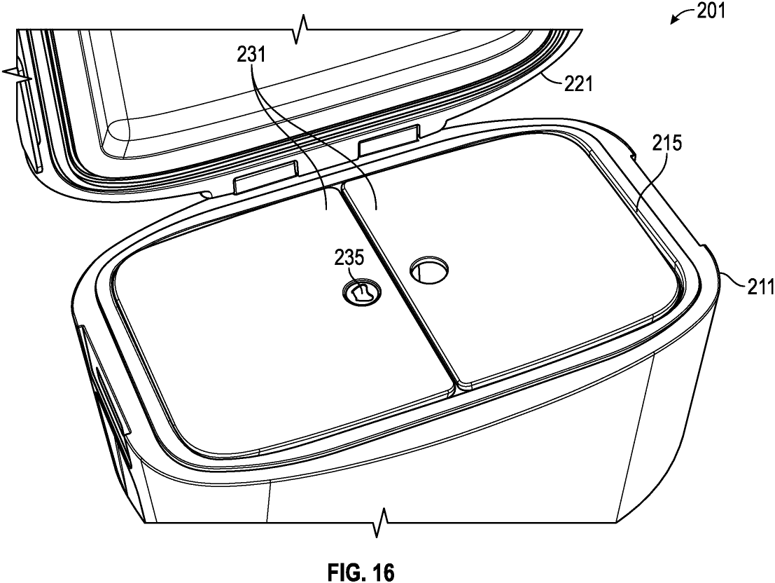

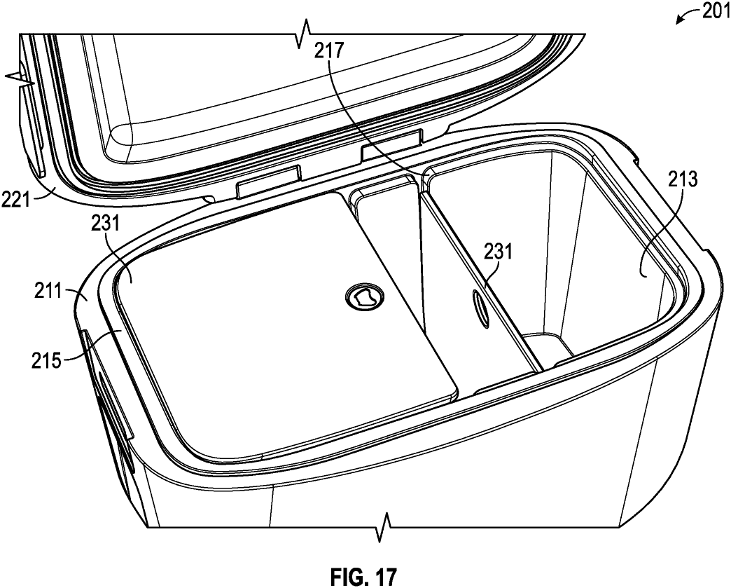

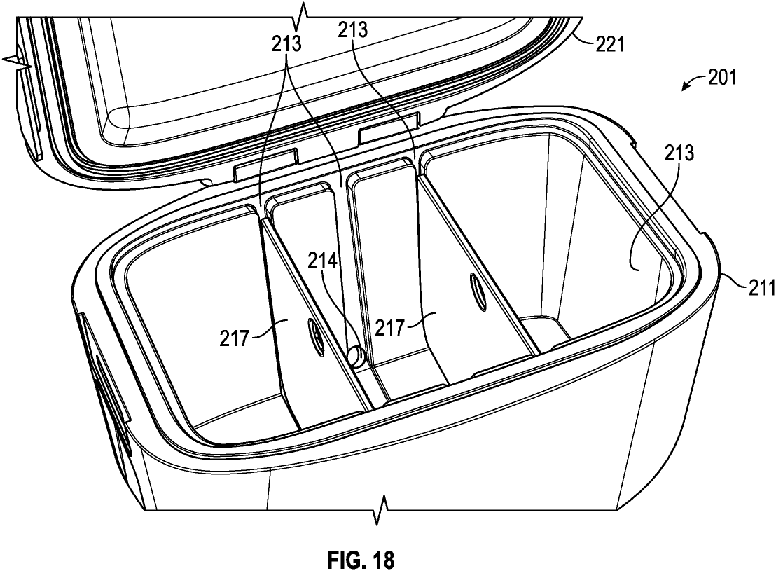

In FIG. 15, the cutting boards 231 are shown mounted to an underside of the lid 221, such as in a press-fit manner so they are secured in place to easily fall out of the lid 221. The cutting boards 231 can be easily and manually removed from the lid 221 when desired. In FIG. 16, the cutting boards 231 are shown seated in (such as loosely or by press-fit) or on the internal rim 215 of the body 211 in a cover position. In FIG. 17, the cutting board 231 on the right is shown mounted in one of the slots 217, while the other cutting board 231 is placed or mounted in or on the internal rim 215 of the body 211.

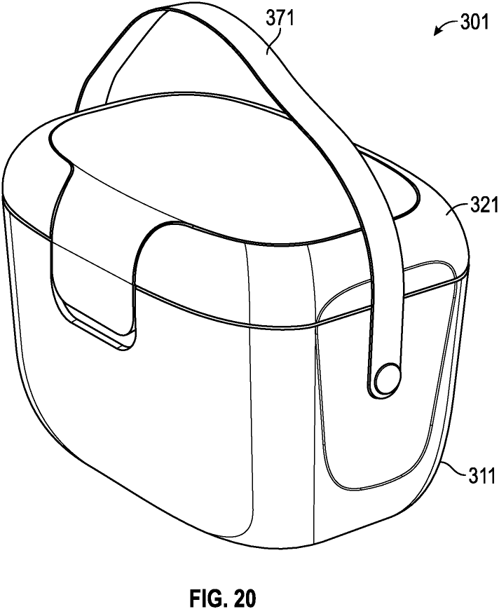

In FIG. 19, the cutting boards 231 are shown slidably mounted together in a vertical orientation in the center slot 217. To accommodate both cutting boards 231, note that the center slot 213 is about twice as wide as the two outer slots 217. This is another optional partition position to divide the interior volume 213 of the body 211 into just two sub-volumes.

Like the previous embodiment of body 111 and lid 121, some examples of the body 211 and the lid 221 can comprise outer perimeter corners that consist of large, enhanced rounded features. The rounded features can have a radius of curvature, such as a minimum radius of curvature. Embodiments of the radius of curvature R can be in a range of about 5% to about 15% of the width of the respective body 211 and lid 221. In other embodiments, the radius of curvature R can be in a range of about 8% to about 12% of the width of the respective body 211 and lid 221.

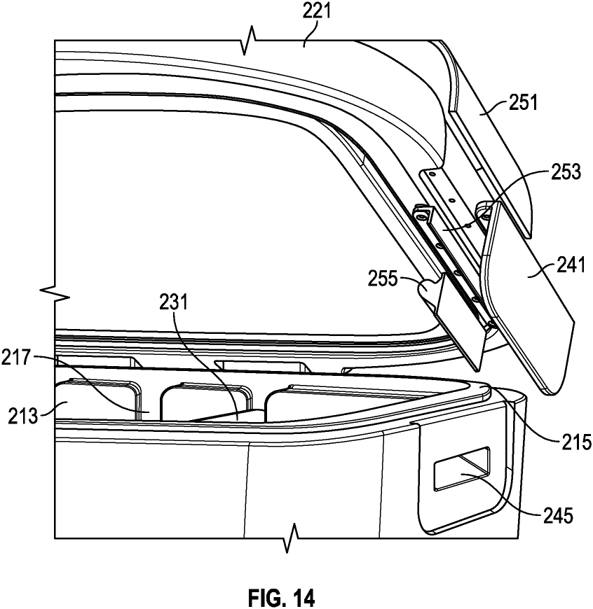

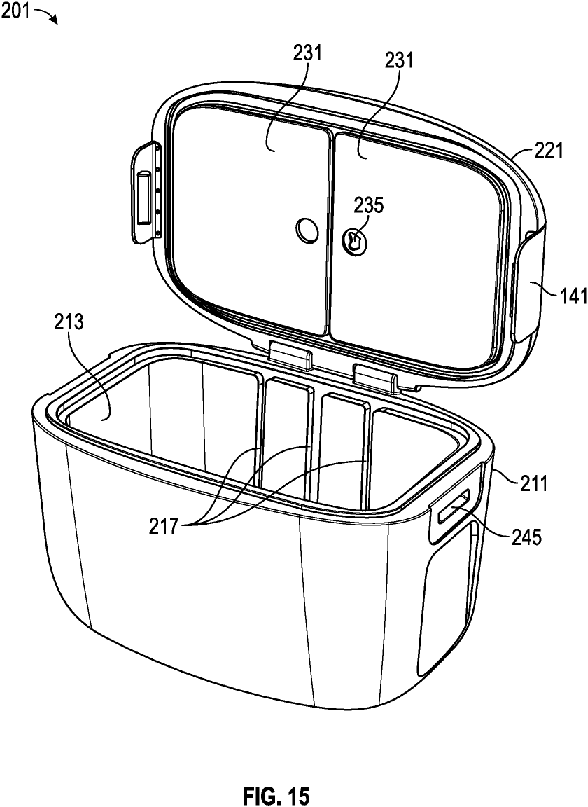

As shown in FIGS. 13-14, versions of the lid 221 can comprise one or more side closures 241 (e.g., two shown), such as clasp-type closures. Embodiments of each side closure 241 can include a rib 243 that is configured, when the lid 221 is in the closed position, to seat in a slot 245 in a side of the body 211, such as at a center of the width of the body 211.

In some embodiments, each side closure 241 can comprise a closure length, also previously described. The closure length can be in a range of about 40% to about 60% of the width of the body 211. Examples of the insulated container 201 can have, in the closed position, outer surfaces of the side closures 241 that are flush or substantially flush with outer surfaces of the sides of the body 211 and/or the lid 221. The side closures 241 can be flexibly cantilevered from the lid 221. The side closures 241 can have a limited range of flexible motion, relative to the lid 221, to secure and release the lid 221 relative to the body 211. In one example, the side closures 241 are flexibly mounted–not pivotally mounted (as in the case of a hinge)--to the lid 221.

Embodiments of the insulated container 201 can further comprise a pad 251 (FIG. 11) mounted to the lid 221. In some versions, the pad 251 is mounted in a recess on top of the lid 221. A top surface of the pad 251 can be flush or substantially flush with a top surface of the lid 221. In an example, the side closures 241 and the pad 251 can be formed together as a single, monolithic, integral silicone structure, or they may comprise separate components that are assembled.

Embodiments of the side closure 241 can further include one or more rigid reinforcements 253, 255 (FIG. 14). Each rigid reinforcement 253, 255 can comprise an injection-molded polymer that can be harder and stronger than the side closure 241 or pad 251. The rigid reinforcements 253, 255 can be molded inside the side closure 241. The rigid reinforcement 253 can fastened to an underside of the lid 221 at an upper end of the side closure 241. The other rigid reinforcement 255 can be molded inside a lower end of the side closure 241.

Embodiments of the insulated container 201 can further include forming the body 211 with lateral recesses, such as concave sides 261 (FIGS. 11-12). Each of the concave sides 261 can include a handle 263. Each handle 263 can be an integrated, recessed body handle adjacent an upper end of the body 211.

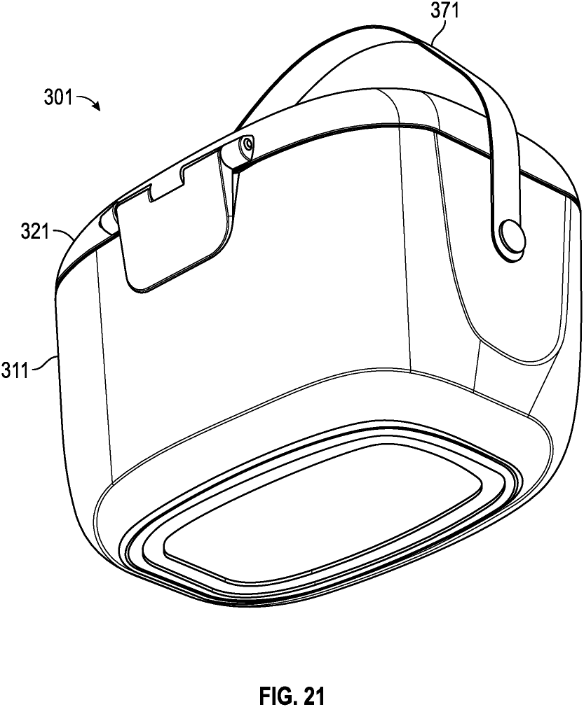

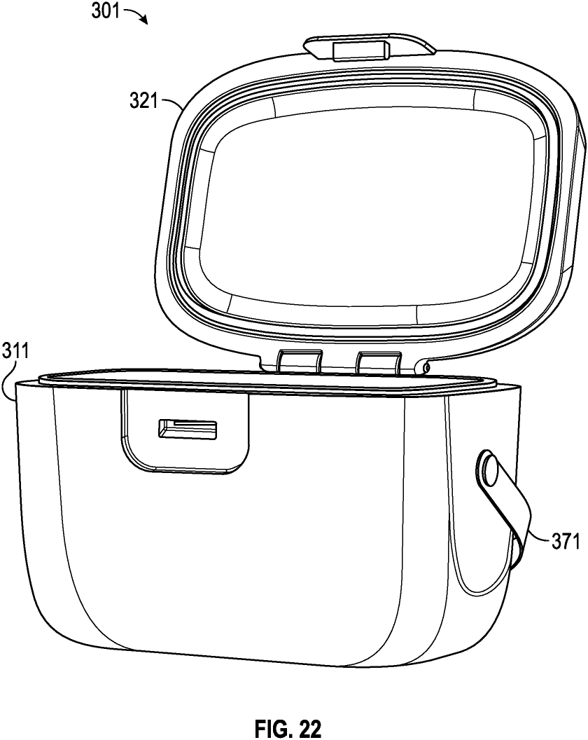

FIGS. 20-22 depict another embodiment of an insulated container 301. Insulated container 301 is similar and, in some ways, almost identical to the other embodiments described herein. In some versions, the insulated container 301 is the smallest of the embodiments disclosed herein. The insulated container 301 includes a body 311, a lid 321 and a handle 371. The handle 371 can comprise a flexible strap, as shown. One or more of the various features, components and elements of the other embodiments may be incorporated into the insulated container 301.

Other embodiments may include one or more of the following items.

1. An insulated container, comprising:
a body having a length, width and height, an interior volume, an internal rim and an internal slot extending into the interior volume;
a lid pivotally coupled to the body and having an open position to expose the interior volume of the body, and a closed position to cover and seal the interior volume of the body; and
a cutting board having an outer perimeter that is complementary in shape to the internal rim of the body, such that the cutting board is configured to seat on the internal rim of the body in a cover position and, alternatively, the cutting board is configured to seat in the internal slot in a partition position to divide the interior volume of the body into sub-volumes.

2. The insulated container wherein each of the body and the lid comprises outer perimeter corners that consist of enhanced rounded features having a radius of curvature that is in a range of about 5% to about 15% of the width of the respective body and lid.

3. The insulated container wherein the lid comprises a clasp-type closure with a rib that is configured, when the lid is in the closed position, to seat in a slot.

4. The insulated container wherein the clasp-type closure consists of a single, clasp-type closure on a front of the lid, and the slot is in a front of the body at a center of the length of the body.

5. The insulated container wherein the clasp-type closure comprises a clasp-type closure on each side of the lid, and the slot comprises slots on each side of the body for respective ones of the clasp-type closures.

6. The insulated container wherein the clasp-type closure comprises a closure length that is about 20% to about 40% of the length of the body.

7. The insulated container wherein, in the closed position, outer surfaces of the clasp-type closure are flush with outer surfaces of both the body and the lid.

8. The insulated container wherein the clasp-type closure is flexibly cantilevered from the lid, not pivotally mounted, and has a limited range of flexible motion to secure and release the lid relative to the body.

9. The insulated container further comprising a pad mounted in a recess on top of the lid, and a top surface of the pad is flush with a top surface of the lid.

10. The insulated container wherein the clasp-type closure and the pad are formed together as a single, monolithic, integral silicone structure.

11. The insulated container wherein the clasp-type closure comprises one or more rigid reinforcements.

12. The insulated container wherein the cutting board comprises a bottle opener that is formed integrally within the cutting board.

13. The insulated container wherein the cutting board is molded around the bottle opener, and the cutting board has apertures to provide access to the bottle opener from both major surfaces of the cutting board.

14. The insulated container wherein the internal rim is horizontal and circumscribes an upper end of the body, such that the cutting board is horizontal in the cover position; and

the internal slot is vertical, such that the cutting board is vertical in the partition position.

15. The insulated container wherein a surface area of the cutting board comprises about half of an upper surface area of the interior volume of the body such that, in the cover position, the cutting board covers about half of the interior volume of the body.

16. The insulated container wherein, in the cover position, the cutting board is reversible on the internal rim to cover either side of the interior volume of the body, such that there are two cover positions.

17. The insulated container wherein, in a first one of the cover positions, the cutting board has a first orientation and, in a second one of the cover positions, the cutting board has a second orientation that comprises a mirror-image of the first orientation.

18. The insulated container wherein the cover position further comprises mounting the cutting board to an underside of the lid in a press-fit manner.

19. The insulated container wherein the body comprises a drain port that is threaded, a plug that is threaded is releasably mounted in the drain port and, when the plug is fully seated, an exterior of the plug is flush with an exterior of the body.

20. An insulated container, comprising:
a body having a length, width and height, an interior volume, an internal rim and an internal slot extending into the interior volume;
a lid pivotally coupled to the body and having an open position to expose the interior volume of the body, and a closed position to cover and seal the interior volume of the body;
a cutting board having an outer perimeter that is complementary in shape to the internal rim of the body, such that the cutting board is configured to seat on the internal rim of the body in a cover position and, alternatively, the cutting board is configured to seat in the internal slot in a partition position to divide the interior volume of the body into sub-volumes;
wherein the internal rim is horizontal and circumscribes an upper end of the body, such that the cutting board is horizontal in the cover position, and the internal slot is vertical, such that the cutting board is vertical in the partition position; and
each of the body and the lid comprises outer perimeter corners that consist of enhanced rounded features having a radius of curvature that is in a range of about 5% to about 15% of the width of the respective body and lid.

21. The insulated container wherein the lid comprises a gasket seated in a groove in an interior lower surface of the lid, and the body comprises a raised lip that circumscribes an upper surface of the body and seats against the gasket when the lid is in the closed position.

22. The insulated container wherein the body comprises concave lateral sides, each of which comprises an integrated, recessed body handle adjacent an upper end of the body.

23. The insulated container further comprising a tubular handle that is curved and has ends, and each end of the tubular handle intersects and is mounted to the body at the respective concave lateral sides of the body beneath the respective body handles.

24. The insulated container wherein each of the body and lid is rotationally molded and comprises polyethylene.

The terminology used herein is for the purpose of describing particular examples and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element’s or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

We claim:

1. An insulated container, comprising:
a body having a length, width and height, an interior volume, an internal rim and an internal slot extending into the interior volume;
a lid pivotally coupled to the body and having an open position to expose the interior volume of the body, and a closed position to cover and seal the interior volume of the body; and
a cutting board having an outer perimeter that is complementary in shape to the internal rim of the body, such that the cutting board is configured to seat on the internal rim of the body in a cover position and, alternatively, the cutting board is configured to seat in the internal slot in a partition position to divide the interior volume of the body into sub-volumes.

2. The insulated container of claim 1, wherein each of the body and the lid comprises outer perimeter corners that consist of enhanced rounded features having a radius of curvature that is in a range of about 5% to about 15% of the width of the respective body and lid.

3. The insulated container of claim 1, wherein the lid comprises a clasp-type closure with a rib that is configured, when the lid is in the closed position, to seat in a slot.

4. The insulated container of claim 3, wherein the clasp-type closure consists of a single, clasp-type closure on a front of the lid, and the slot is in a front of the body at a center of the length of the body.

5. The insulated container of claim 3, wherein the clasp-type closure comprises a clasp-type closure on each side of the lid, and the slot comprises slots on each side of the body for respective ones of the clasp-type closures.

6. The insulated container of claim 3, wherein the clasp-type closure comprises a closure length that is about 20% to about 40% of the length of the body.

7. The insulated container of claim 3 wherein, in the closed position, outer surfaces of the clasp-type closure are flush with outer surfaces of both the body and the lid.

8. The insulated container of claim 3, wherein the clasp-type closure is flexibly cantilevered from the lid, not pivotally mounted, and has a limited range of flexible motion to secure and release the lid relative to the body.

9. The insulated container of claim 3, further comprising a pad mounted in a recess on top of the lid, and a top surface of the pad is flush with a top surface of the lid.

10. The insulated container of claim 9, wherein the clasp-type closure and the pad are formed together as a single, monolithic, integral silicone structure.

11. The insulated container of claim 3, wherein the clasp-type closure comprises one or more rigid reinforcements.

12. The insulated container of claim 1, wherein the cutting board comprises a bottle opener that is formed integrally within the cutting board.

13. The insulated container of claim 12, wherein the cutting board is molded around the bottle opener, and the cutting board has apertures to provide access to the bottle opener from both major surfaces of the cutting board.

14. The insulated container of claim 1, wherein the internal rim is horizontal and circumscribes an upper end of the body, such that the cutting board is horizontal in the cover position; and
the internal slot is vertical, such that the cutting board is vertical in the partition position.

15. The insulated container of claim 1, wherein a surface area of the cutting board comprises about half of an upper surface area of the interior volume of the body such that, in the cover position, the cutting board covers about half of the interior volume of the body.

16. The insulated container of claim 1 wherein, in the cover position, the cutting board is reversible on the internal rim to cover either side of the interior volume of the body, such that there are two cover positions.

17. The insulated container of claim 16 wherein, in a first one of the cover positions, the cutting board has a first orientation and, in a second one of the cover positions, the cutting board has a second orientation that comprises a mirror-image of the first orientation.

18. The insulated container of claim 1, wherein the cover position further comprises mounting the cutting board to an underside of the lid in a press-fit manner.

19. The insulated container of claim 1, wherein the body comprises a drain port that is threaded, a plug that is threaded is releasably mounted in the drain port and, when the plug is fully seated, an exterior of the plug is flush with an exterior of the body.

20. An insulated container, comprising:
a body having a length, width and height, an interior volume, an internal rim and an internal slot extending into the interior volume;
a lid pivotally coupled to the body and having an open position to expose the interior volume of the body, and a closed position to cover and seal the interior volume of the body;
a cutting board having an outer perimeter that is complementary in shape to the internal rim of the body, such that the cutting board is configured to seat on the internal rim of the body in a cover position and, alternatively, the cutting board is configured to seat in the internal slot in a partition position to divide the interior volume of the body into sub-volumes;
wherein the internal rim is horizontal and circumscribes an upper end of the body, such that the cutting board is horizontal in the cover position, and the internal slot is vertical, such that the cutting board is vertical in the partition position; and
each of the body and the lid comprises outer perimeter corners that consist of enhanced rounded features having a radius of curvature that is in a range of about 5% to about 15% of the width of the respective body and lid.
